(19) United States
(12) Patent Application Publication
(10) Pub. No.: US 2008/0291298 A1
(43) Pub. Date: Nov. 27, 2008

(54) IMAGE NOISE REDUCTION APPARATUS AND METHOD

(75) Inventors: Soo-young KIM, Suwon-si (KR); Dong-bum CHOI, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/867,883

(22) Filed: Oct. 5, 2007

(30) Foreign Application Priority Data
Apr. 23, 2007 (KR) 10-2007-0039436

(51) Int. Cl. H04N 5/225

(52) U.S. Cl. 348/241; 348/E05.024

(57) ABSTRACT

Provided is an image noise reduction method and apparatus in consideration of brightness of an image in a camera using an image pickup device such as a charge-coupled device (CCD) or a complementary metal-oxide-semiconductor (CMOS). The method includes: detecting a degree of image motion by using data from a plurality of frames which are picked up; detecting brightness of an image which is picked up; determining a ratio between current frame data and previous frame data according to the image motion degree and the brightness of the image; and combining the current frame data with the previous frame data according to the determined frame data ratio.

### CROSS-REFERENCE TO RELATED PATENT APPLICATION

This application claims the benefit of Korean Patent Application No. 10-2007-0039436, filed on Apr. 23, 2007, in the Korean Intellectual Property Office, the disclosure of which is incorporated herein in its entirety by reference.

### BACKGROUND OF THE INVENTION

1. Field of the Invention

The present invention relates to a video signal processing apparatus and method, and more particularly, to an image noise reduction apparatus and method taking into consideration the brightness of a video in a camera using an image pickup device such as a charge-coupled device (CCD) or a complementary metal-oxide-semiconductor (CMOS).

2. Description of the Related Art

In general, a video camera electrically records 2D information on an object. The video camera converts an optical image of the object into an electric image to store the electric image in a memory unit, and reads the image stored in the memory as needed to print the image or transmit the image to a computer. The video camera uses an image pickup device such as a charge-coupled device (CCD) or a complementary metal-oxide-semiconductor (CMOS).

The image pickup time of the image pickup device in the video camera is 1/60 second. The video camera outputs images at 60 fields per second and in a pickup period, continuously outputs picked-up images stored in the memory to maintain continuity of the images.

Image pickup devices such as a CCD or CMOS generate fixed-pattern noise including noise from defective pixels. The fixed-pattern noise occurs due to non-uniformity caused by various factors in the process of manufacturing the CMOS or the CCD and has types such as white/black/longitudinal/splotchy defects and sensitivity unevenness. A CCD or CMOS camera is driven by various switching pulses and generates reset noise due to the switching pulses. In addition, dark current noise is referred to as thermal noise which has a characteristic proportional to temperature, and the dark current noise causes video quality deterioration.

The camera reconstructs light as an electric image signal by using an image pickup device such as a CMOS or CCD. When light is sufficient, that is, the photographing environment is bright, noise in the CCD is significantly smaller than charges that are photoelectrically converted by light and stored, so that the image pickup device has little image quality deterioration. However, when the photographing environment is dark, there is a problem in that the image pickup device has fixed-pattern noise, dark current noise, and sensor reset noise which are relatively larger in magnitude than charges that are photoelectrically converted by light and stored.

### SUMMARY OF THE INVENTION

The present invention provides an image noise reduction apparatus and method capable of reducing image noise which has a low temporal correlation in consideration of the brightness of an image or a photographing environment.

The present invention also provides a video camera system capable of reducing noise and video deterioration in consideration of motion information, image brightness, or the brightness of the photographing environment.

According to an aspect of the present invention, there is provided an image noise reduction method, comprising:

detecting a degree of image motion by using data from a plurality of frames which are picked up;

detecting the brightness of an image which is picked up;

determining a ratio between current frame data and previous frame data according to the image motion degree and the brightness of the image; and

combining the current frame data with the previous frame data according to the determined frame data ratio.

According to another aspect of the present invention, there is provided an image noise reduction apparatus, comprising:

a motion detector detecting image motion information by using data from a plurality of frames which are picked up;

a gain determiner determining gain coefficients used to determine a ratio between current frame data and previous frame data on the basis of the motion information and brightness information on an image; and

a filter combining the current frame data with the previous frame data according to the gain coefficients set by the gain determiner.

According to another aspect of the present invention, there is provided a video camera system comprising:

an image pickup device picking up an object image formed on a plane of incidence and outputting a corresponding analog image signal;

an analog signal processor performing auto gain control on the analog image signal output from the image pickup device by AGC;

an analog-digital converter converting the analog image signal output from the analog signal processor into a digital image signal;

a digital signal processor detecting a degree of image motion by using an image signal from a plurality of frames output by the analog-digital converter, setting gain coefficients which are used to determine a ratio between current frame data and previous frame data according to the motion degree and brightness of the picked-up images, and combining the current frame data with the previous frame data according to the gain coefficients.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a video camera system applying an image noise reduction apparatus according to an embodiment of the present invention;

FIG. 2 is a block diagram showing an image noise reduction apparatus performed in a digital signal processor shown in FIG. 1;

FIG. 3 is a flowchart showing an image noise reduction method according to an embodiment of the present invention; and

FIG. 4 is a graph showing gain characteristics according to an embodiment of the present invention.

### DETAILED DESCRIPTION OF THE INVENTION

Hereinafter, exemplary embodiments of the present invention will be described in detail with reference to the attached drawings.

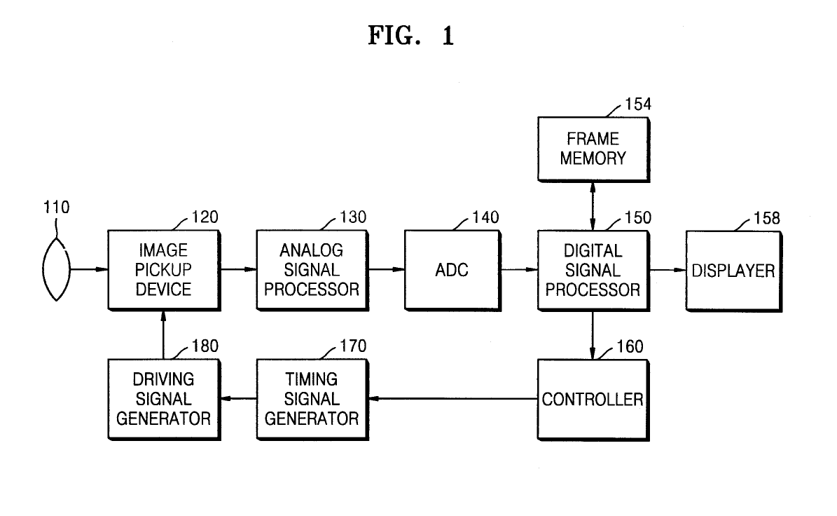

FIG. 1 is a block diagram showing a video camera system applying an image noise reduction apparatus according to an embodiment of the present invention.

The video camera system shown in FIG. 1 includes a photographing lens 110, an image pickup device 120, an analog signal processor 130, an analog-digital converter (ADC) 140, a digital signal processor 150, a frame memory 154, a displayer 158, a controller 160, a timing signal generator 170, and a driving signal generator 180.

The photographing lens 110 forms an image of an object to be photographed on a plane of incidence of the image pickup device 120.

The image pickup device 120 may have a charge-coupled device (CCD) type or a complementary metal-oxide-semiconductor (CMOS) type. The image pickup device 120 picks up the image of the object formed on the plane of incidence to output a corresponding analog RGB or YCbCr image signal.

The analog signal processor 130 performs correlated double sampling on the analog RGB signal output by the image pickup device 120 and automatically controls the gain of the RGB analog signal through auto gain control (AGC). For example, when the object is bright and the signal level is high, the analog signal processor 130 decreases the AGC gain, and when the object is dark and the analog signal level is low, the analog signal processor 130 increases the AGC gain.

The ADC 140 converts the RGB analog signal output from the analog signal processor 130 into an RGB digital signal. In addition, the ADC 140 converts the AGC gain determined in the analog signal processor 130 into a digital value.

The digital signal processor 150 reduces noise in the RGB digital signal output from the ADC 140 by using a noise reduction apparatus having functions including definition calibration, color calibration, gamma calibration, temporal filtering, and the like, converts the RGB digital signal into a YCbCr signal for display, and generates a horizontal and vertical synchronization signal. In particular, the digital signal processor 150 detects a degree of image motion by using data from a plurality of picked-up frames, calculates an average pixel value of a frame or an average pixel value of a block, detects brightness of a picked-up image by using the AGC gain or the average pixel value of the frame, determines a ratio of combination between current frame data and previous frame data according to the motion degree and the brightness of the image, and combines the current frame data with the previous frame data according to the data combination ratio. Here, the previous frame is stored in the frame memory 154 and is an image signal of a temporal-filtered frame.

The frame memory 154 stores an RGB signal corresponding to the frame processed in the digital signal processor 150.

The displayer 158 may be a liquid crystal display (LCD) or a plasma display panel (PDP) and displays a YCbCr signal output from the digital signal processor 150.

The controller 160 passes the horizontal and vertical synchronizing signal generated by the digital signal processor 150 to the timing signal generator 170 and controls each function operation according to the operation instructions of a user.

The timing signal generator 170 generates a timing signal according to the horizontal and vertical synchronization signal output from the controller 160.

The driving signal generator 180 generates a driving signal for driving the image signal pickup operation of the image pickup device 120 according to the timing signal generated by the timing generator 170.

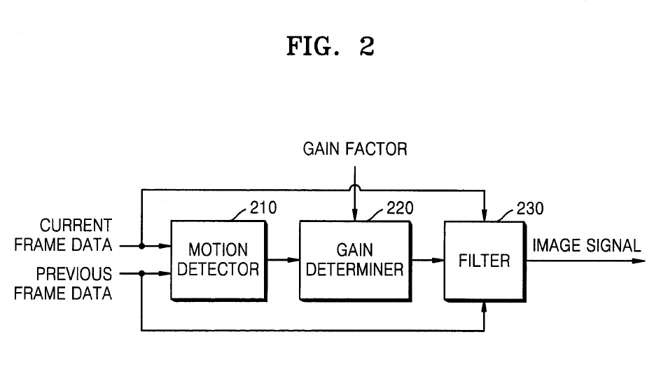

FIG. 2 is a block diagram showing the image noise reduction apparatus performed in the digital signal processor 150 shown in FIG. 1.

The image noise reduction apparatus shown in FIG. 2 includes a motion detector 210, a gain determiner 220, and a filter 230.

The motion detector 210 detects a degree of image motion by using data from the current frame and a previous frame. According to an embodiment of the present invention, the motion detector 210 uses a sum absolute difference (SAD). More specifically, the motion detector 210 obtains a difference value between the luminance signal of the current frame and the luminance signal of the previous frame and obtains a sum in block units for the difference value. Here, if the SAD value is large, the motion degree is determined to be large, and if the SAD value is small, the motion degree is determined to be small.

The gain determiner 220 determines gain coefficients α′ and β′ for the combination of the current frame data and the previous frame data according to the motion degree value detected by the motion detector 210 and a gain factor. Here, the gain factor is, for example, brightness information for a photographing environment or brightness information for an image. The brightness information for the photographing environment may be represented as an AGC gain value generated by the analog signal processor 130. The brightness information on the image may be represented as the average pixel value of a frame in the digital signal processor 150.

The filter 230 performs temporal filtering and combines the current frame data and the previous frame data according to the gain coefficients α′ and β′ of each of the frames determined by the gain determiner 220.

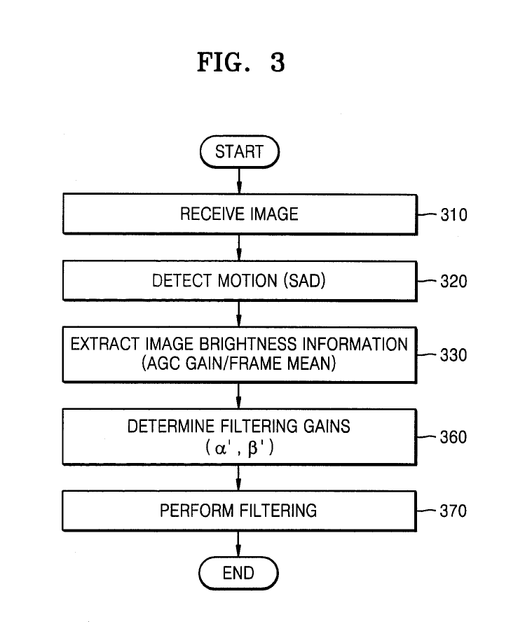

FIG. 3 is a flowchart showing an image noise reduction method according to an embodiment of the present invention.

First, an image signal in continuous frame units is input (operation 310).

Next, a degree of image motion is detected by using data from the current frame and previous frames (operation 320). According to an embodiment of the present invention, the motion degree may be represented as a sum absolute difference (SAD). Here, as an SAD value becomes larger, the motion degree becomes larger, and as the SAD value becomes smaller, the motion degree becomes smaller.

Here, the magnitude of noise changes according to the brightness of an image. Therefore, image brightness information such as the AGC gain, the average pixel value of a frame, or the average pixel value of a block is extracted (operation 330). Conventionally, when the brightness of an image is high, the noise level is relatively low compared to the image signal level, and when the brightness of an image is low, the noise level is relatively high compared to the image signal level.

Next, filtering gain coefficients α′ and β′ for a combination of the current frame data and the previous frame data are determined according to the SAD value and the image brightness information (the AGC gain or the average pixel value of the frame) (operation 360). Here, the current frame data and the previous frame data have a high correlation, so that by using the combination of the two frames, noise having a temporally low correlation between frames can be reduced.

For example, when the SAD value is larger than a predetermined threshold, the current frame data gain α is set to be larger than the previous frame data gain β, and when the SAD value is smaller than the threshold, the current frame data gain α is set to be smaller than the previous frame data gain β. In other words, if the SAD value is large, the current frame data ratio is set to be larger than the data ratio of the previous frame, and if the SAD value is small, the current frame data ratio is set to be smaller than the previous frame data ratio. Therefore, according to the motion degree, the previous frame data ratio and the current frame data ratio are set and combined. Thus, image deterioration due to a sum of the previous frame and the current frame can be prevented by adjusting the current frame data ratio and the previous frame data ratio.

In addition, the gain coefficients α and β applying the motion information are updated along with the gain coefficients α′ and β′ applying the brightness information.

For example, when the AGC gain is higher than a threshold, it is determined that the photographing environment is dark, so that among the gain coefficients α and β applying motion information, the gain coefficient of the current frame is lowered to be smaller than the gain coefficient of the previous frame. When the AGC gain is lower than the threshold, it is determined that the photographing environment is bright, so that among the gain coefficients α and β applying the motion information, the gain coefficient of the current frame is raised to be larger than the gain coefficient of the previous frame.

Therefore, the gain coefficients α′ and β′ applying the AGC gain may be represented by Equation 1.

α′=α/AGC gain value

β′=1−α′ [Equation 1]

In other words, if the AGC gain is high, in order to reduce noise, the current frame data ratio is raised to be higher than the previous frame data ratio, and if the AGC gain is low, the current frame data ratio is lowered to be smaller than the previous frame data ratio. Therefore, by adjusting the previous frame data ratio and the current frame data ratio applying the motion information according to the photographing environment, noise reduction efficiency increases. Here, “previous frame data” means an image signal from which a noise component is filtered.

In addition, when the average pixel value of the frame is higher than a threshold, it represents a bright environment, so that among the gain coefficients α and β applying the motion information, the gain coefficient of the current frame is raised to be higher than the gain coefficient of the previous frame. When the average pixel value of the frame is lower than the threshold, it represents a dark environment, so that among the gain coefficients α and β applying the motion information, the gain coefficient of the current frame is lowered to be lower than the gain coefficient of the previous frame.

Therefore, the gain coefficients α′ and β′ applying the average pixel value of the frame may be represented by Equation 2.

α′=frame average pixel value*α

β′=1−α′ [Equation 2]

Therefore, by adjusting the ratio between the previous frame data and the current frame data applying the motion information according to the brightness of the video, noise reduction efficiency can be increased.

Next, by combining the current frame data with the previous frame data as shown in Equation 3 according to the finally determined gain coefficients α′ and β′, temporal filtering is performed on the image signal (operation 370).

y_{tf}(t)=α′·y(t)+β′·y_{tf}(t−1) [Equation 3]

Where y_{tf}(t) denotes a temporal-filtered output image signal, y(t) denotes data of the current frame, y_{tf}(1) denotes data of the previous frame, α′ is the gain coefficient of the current frame, and β′ denotes the gain coefficient of the previous frame. Here, the α′ and β′ values are determined according to the SAD value, the AGC gain, or the average pixel value of the frame. In addition, α′+β′=1.

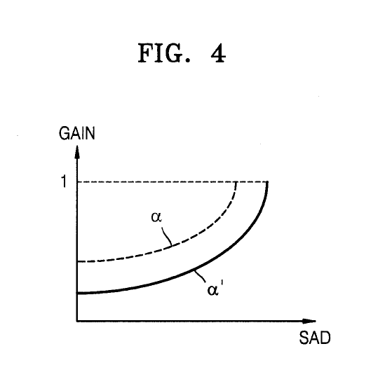

FIG. 4 is a graph showing gain characteristics according to an embodiment of the present invention.

Referring to FIG. 4, α is the gain coefficient of the current frame data according to the SAD value. As the SAD increases, the gain coefficient α increases. In addition, α′ is the gain coefficient of the current frame data according to the SAD, the AGC gain, and/or the average pixel value of the frame. The gain coefficients α′ and β′ according to the SAD, the AGC, and/or the average pixel value of the frame may be represented by Equation 4.

alpha′=k TIMES{{FrameMean}over{{AGC}}TIMES alpha

β′=1−α′ [Equation 4]

Where k denotes a factor for normalization, AGC denotes the AGC gain, and FrameMean denotes the frame's average pixel value.

Therefore, as shown in FIG. 4, as the AGC gain increases and the average pixel value of the frame decreases, the gain coefficient α for the SAD decreases and is generated as a new gain coefficient α′.

Accordingly, in consideration of the motion degree and brightness of the image when a digital camera picks up an image, by properly adjusting a ratio between data from the current frame and data from the previous frame, image deterioration due to the sum of data from both frames and noise which occurs in an image pickup device can be reduced.

The present invention can also be embodied as computer-readable codes on a computer-readable recording medium. The computer-readable recording medium may be any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An image noise reduction method, comprising:
detecting a degree of image motion by using data of a plurality of frames which are picked up;
detecting brightness of an image which is picked up;
determining a ratio between current frame data and previous frame data according to the image motion degree and the brightness of the image; and
combining the current frame data with the previous frame data according to the determined frame data ratio.

2. The method of claim 1, wherein the image brightness information is an AGC (auto gain control) gain.

3. The method of claim 1, wherein the image brightness information is an average pixel value of a frame.

4. The method of claim 1, wherein the image brightness information is an average pixel value of an image block.

5. The method of claim 1, wherein the image motion degree is a sum of absolute differences between a luminance value of the current frame and a luminance value of the previous frame.

6. The method of claim 1, wherein in determining the data ratio, when an SAD (sum absolute difference) value is larger than a predetermined threshold, a ratio of the current frame data is set to be larger than a ratio of the data of the previous frame data.

7. The method of claim 1, wherein in determining the data ratio, when a magnitude of an AGC gain is larger than a predetermined threshold, in a data combination according to an SAD value, a ratio of the current frame is lowered to be smaller than that of the previous frame.

8. The method of claim 1, wherein in determining the data ratio, when an average pixel value of a frame is larger than a predetermined threshold, in a data combination according to an SAD value, a ratio of the current frame is increased to be larger than that of the previous frame.

9. The method of claim 1, wherein in determining the data ratio, when an average pixel value of a block is larger than a predetermined threshold, in a data combination according to an SAD value, a ratio of the current frame is increased to be larger than that of the previous frame.

10. An image noise reduction apparatus, comprising:
a motion detector detecting image motion information by using data of a plurality of frames which are picked up;
a gain determiner determining gain coefficients used to determine a ratio between current frame data and previous frame data on the basis of the motion information and brightness information on an image; and
a filter combining the current frame data with the previous frame data according to the gain coefficients set by the gain determiner.

11. The apparatus of claim 10, wherein the brightness information on the image is an AGC gain or an average pixel value of a frame.

12. A video camera system comprising:
an image pickup device picking up an object image formed on a plane of incidence and outputting a corresponding analog image signal;
an analog signal processor performing auto gain control on the analog image signal output from the image pickup device by AGC;
an analog-digital converter converting the analog image signal output from the analog signal processor into a digital image signal;
a digital signal processor detecting a degree of image motion by using an image signal of a plurality of frames output from the analog-digital converter, setting gain coefficients which are used to determine a ratio between current frame data and previous frame data according to the motion degree and brightness of the picked up images, and combining the current frame data with the previous frame data according to the gain coefficients.

13. The system of claim 12, wherein the digital signal processor comprises:
a motion detector detecting image motion information by using the data of a plurality of the frames which are picked up;
a gain determiner determining the gain coefficients which are used to determine the ratio between the current frame data and the previous frame data, on the basis of the motion information and the brightness information on the image; and
a filter combining the current frame data with the previous frame data according to the determined gain coefficients.
